(19) United States
(12) Patent Application Publication
(10) Pub. No.: US 2025/0000307 A1
(43) Pub. Date: Jan. 2, 2025

(54) SOAP DISPENSER

(71) Applicant: ODONATA INTERNATIONAL LIMITED, Cardiff (GB)

(72) Inventor: Lisa Hicks, Monmouth (GB)

(73) Assignee: ODONATA INTERNATIONAL LIMITED, Cardiff, WL (GB)

(21) Appl. No.: 18/701,205

(22) PCT Filed: Oct. 13, 2022
(86) PCT No.: PCT/GB2022/052611

§ 371 Date: Apr. 12, 2024

(30) Foreign Application Priority Data
Oct. 13, 2021 (GB) 2114658.4
Oct. 13, 2021 (GB) 2114659.2

(51) Int. Cl. A47K 5/09

(52) U.S. Cl. CPC A47K 5/09

(57) ABSTRACT

A soap dispenser comprising: a housing having an opening for inserting a bar of soap; a grating element for shaving particles of soap from the bar; a driving mechanism for both rotating the bar of soap about an axis and urging the bar of soap downwards onto the grating element to generate soap particles which are ejected from the bottom of the dispenser; and a centring element for maintaining the soap centred on the axis as it rotates and as it wears.

### FIELD OF THE INVENTION

The present invention relates to soap dispensers, and more particularly, to a dispenser for receiving a bar of soap and for dispensing particles of soap resulting from the bar of soap being ground by a grinder located inside of the dispenser.

### BACKGROUND OF THE INVENTION

Solid soap bars are well known. However, they can be messy to use and are not ideal for communal situations.

Soap dispensers which dispense liquid detergent or soap are commonly used in communal situations. However, liquid detergent typically has a mass of 6 times as much as the equivalent amount of solid soap (largely due to the water content) which must be transported with a corresponding carbon footprint. It is also generally supplied in single use plastic containers, which have an environmental impact. Solid soap would be environmentally preferable.

Soap dispensers for receiving a bar of soap and for grinding the bar of soap to dispense particles of soap to a user, have been proposed.

For example, one such known dispenser uses a coil with spikes on it, to act as a grinder for a bar of soap that is inserted into the dispenser. The bar of soap is pushed down by a spring, and the coil turns in a circular motion to grate the bar of soap.

Another known dispenser uses a spring to push a bar of soap against a turning grater.

Solid soap is not the easiest material to work with and known proposed solid soap dispensers generally suffer from the disadvantage that the bar of soap is not grated evenly and accurately and not in a uniform manner, particularly as the soap wears or is exposed to moisture and accordingly have not achieved general acceptance.

Accordingly, the invention is aimed at still achieving the environmental benefits of using a solid bar of soap rather than liquid soap, but at the same time, improving the known dispensers which use a solid bar of soap.

### SUMMARY OF THE INVENTION

The present invention provides a soap dispenser comprising: a housing having an opening for inserting a bar of soap; a grating element for shaving particles of soap from the bar; a driving mechanism for both rotating the bar of soap about an axis and urging the bar of soap downwards onto the grating element to generate soap particles which are ejected from the bottom of the dispenser; and a centring element for maintaining the soap centred on the axis as it rotates and as it wears.

This ensures that a maximum surface of the soap contacts the grating element, to stop the bar of soap from sliding out of position. For example, this stops the bar of soap from getting caught on the inside walls of the housing. This arrangement helps to guide the bar of soap in an accurate manner towards the grating element.

The rotation and downward urging, helps to guide the bar of soap down towards the grater in a very even, uniform, manner, to make maximum use of the bar of soap in creating fine particles for washing.

Preferably, the opening is a door.

Preferably, the housing has threads on an inside surface. These are useful in guiding the rotation of the bar of soap in a controlled manner.

Preferably, the soap dispenser further comprises a handle for turning to generate soap particles which are ejected from the dispenser.

Preferably, the driving mechanism includes a feeder legs element engaged with the handle so that the feeder legs element rotates when the handle is rotated; and a circular feeder element engaged with the feeder legs element, the circular feeder element having threads which engage with the threads on the inside surface of the housing. These features are useful in driving the bar of soap downwards to the grating element in a controlled manner.

Preferably, the grating element is located at the bottom of the housing.

Preferably, more than one bar of soap is inserted into the housing, one on top of the other. This results in less frequent loading of the dispenser.

Preferably, the circular feeder element has a flat bottom undersurface.

Preferably, the flat bottom undersurface of the circular feeder element is arranged to push a bar of soap downwards in the housing.

Preferably, the dispenser is arranged such that the bar of soap is made to rotate as it is pushed downwards by the flat bottom undersufrace of the circular feeder element.

Preferably, the centring element includes a nipple protrusion located at the centre of the grating element and another nipple protrusion located at the centre of the flat bottom undersurface of the circular feeder element, to hold the bar of soap in alignment as it rotates.

Preferably, the soap dispenser is arranged to operate with a bar of soap having a hole at least in each end and desirably a through hole arranged to cooperate with the nipple protrusions. This further helps to hold the bar of soap into position, as it rotates and moves downwards.

Preferably, the handle is turned by hand. This provides the user with control over how fast the soap is rotated.

Preferably, the feeder legs element is attached to the circular feeder element such that when the feeder legs element rotates, the circular feeder element also rotates.

Preferably, the handle has an elongated protrusion of a size that fits into an indentation on the top surface of the feeder legs element, such that rotation of the handle causes rotation of the feeder legs element.

Preferably, the circular feeder element has at least two holes for receiving at least two legs of the feeder legs element. This creates a secure attachment, to better control the movement.

Preferably, the threads of the circular feeder element run in a circumferential direction of the circular feeder element. This allows the threads of the circular feeder element to engage with the threads on the housing's inside surface(s).

Preferably, the feeder legs element and the circular feeder element are arranged in the housing so that they can be slid forward toward the opening but not removed entirely from the housing, and disengaging the threads of the circular feeder element from the threads of the housing, to allow a bar of soap to be loaded into the dispenser. This greatly facilitates the loading process, as the assembly is moved closer to the user, as well as creating a gap into which the bar(s) of soap can be inserted into the dispenser.

### BRIEF DESCRIPTION OF THE DRAWINGS

FIG. 1 is a diagram showing the soap dispenser housing, according to a preferred embodiment of the present invention;

FIG. 2a is a diagram showing the feeder legs element and the circular feeder element, which are to be inserted inside of the housing of FIG. 1, according to a preferred embodiment of the present invention;

FIG. 2b is a diagram showing a bottom view of the circular feeder element by itself;

FIG. 3 shows the overall feeder element of FIG. 2a inserted into the housing of FIG. 1, according to a preferred embodiment of the present invention;

FIG. 4 shows the handle which is located at the top of the housing of FIG. 1, according to a preferred embodiment of the present invention;

FIG. 5 shows the top surface of the feeder legs element;

FIG. 6 shows the insertion of a bar of soap into the housing, according to a preferred embodiment of the present invention;

FIG. 7 shows the grating element, according to a preferred embodiment of the present invention;

FIG. 8 shows the grating element inserted into the housing of FIG. 1, according to a preferred embodiment of the present invention;

FIG. 9 shows the bar of soap at the bottom of the dispenser, being ground into particles by the grater, according to a preferred embodiment of the present invention;

FIG. 10 shows the two nipples used to vertically align the bar of soap within the housing;

FIG. 11 shows a bar of soap, arranged to work with the dispenser;

FIG. 12 shows the bar of soap of FIG. 11 in cross section;

FIG. 13a shows a perspective view of the bar of soap with indented sides according to a preferred embodiment; and

FIG. 13b shows a top view of the bar of soap of FIG. 13a. More preferably, the bar of soap is 64 mm×64 mm×33 mm, with an 8 mm diameter hole.

### DETAILED DESCRIPTION OF THE PREFERRED EMBODIMENTS

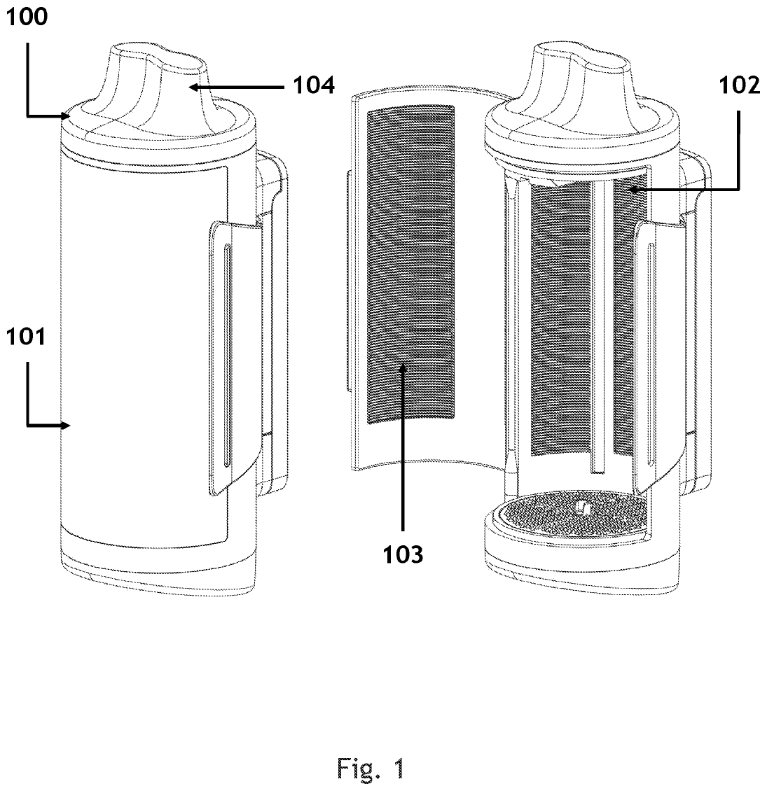

A preferred embodiment of the present invention is shown in FIG. 1, which shows a soap dispenser housing 100 for receiving at least one bar of soap which is to be ground into fine particles by the dispenser.

As shown in FIG. 1, a door 101 is provided for covering the front opening of the dispenser, and when the door is in the open position, at least one bar of soap can be inserted into the opening.

The inside wall 102 of the housing of FIG. 1 is provided with threads, arranged in a diagonal orientation so that they slope downwards. The threads can be located, for example, on the inside wall 103 of the door and on the back inside wall of the housing 102.

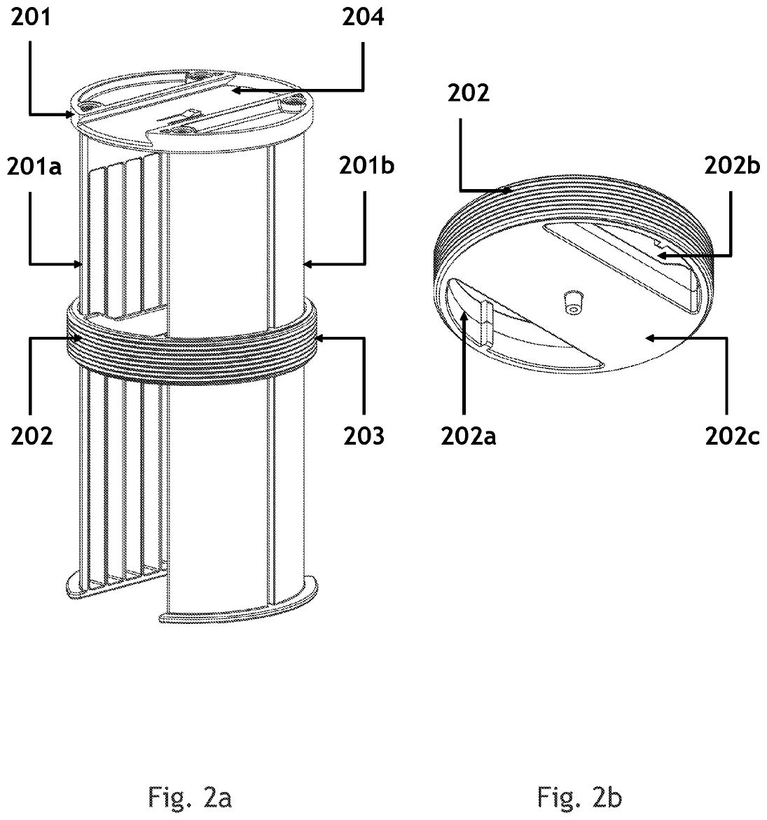

As shown in FIG. 2a, an element 201 having two parallel vertical legs (201a, 201b) is provided for insertion inside of the housing of FIG. 1, in the below description, this will be called the feeder legs element 201. A circular feeder element 202 which is a ring-shaped element with a flat undersurface 202c (shown in FIG. 2b) engages with the feeder legs element 201 such that the vertical legs 201a, 201b of the feeder legs element 201 fit into the holes 202a, 202b (shown in FIG. 2b) in the circular feeder element, so that when the feeder legs element 201 rotates, the circular feeder element 202 also rotates. This circular feeder element 202 has threads 203 on it, with the threads running in the circumferential direction of the circular ring, as shown in FIG. 2a.

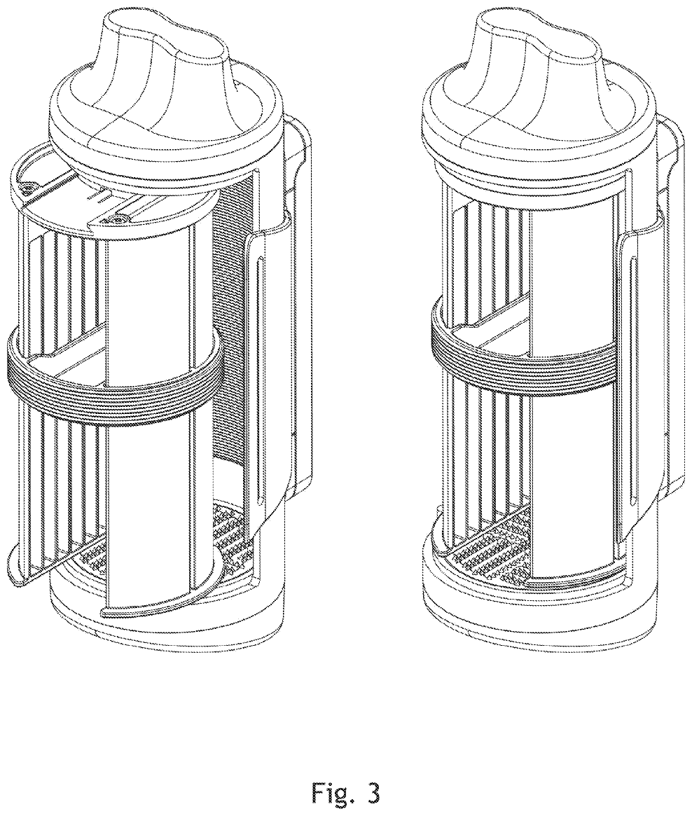

This overall feeder element, the combination of the feeder legs element and the circular feeder element, slides into the housing of FIG. 1, such that the threads of the circular feeder element 202 engage with the threads on the inside walls of the housing. FIG. 3 shows the overall feeder element of FIG. 2a inserted into the housing of FIG. 1. It should be noted that the user does not generally completely remove the combination of the feeder legs element and the circular feeder element from the housing, and instead the user moves forward the combination of the feeder legs element and the circular feeder element to a position slightly outside of the housing, to disengage the threads on the circular feeder element from the threads of the housing. This allows the user to easily load a bar of soap into the housing of the dispenser. Finger grips (indentations) can be formed in the side of the feeder legs element, to facilitate the user moving forward the feeder assembly as just described.

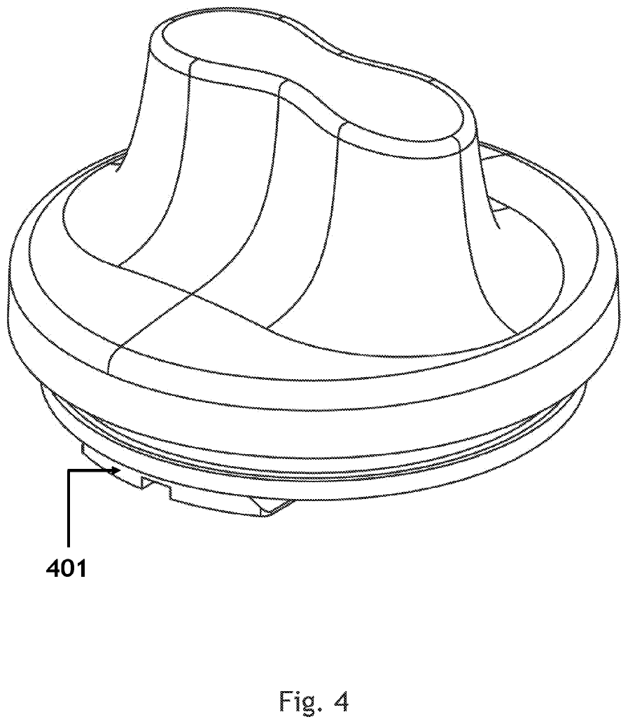

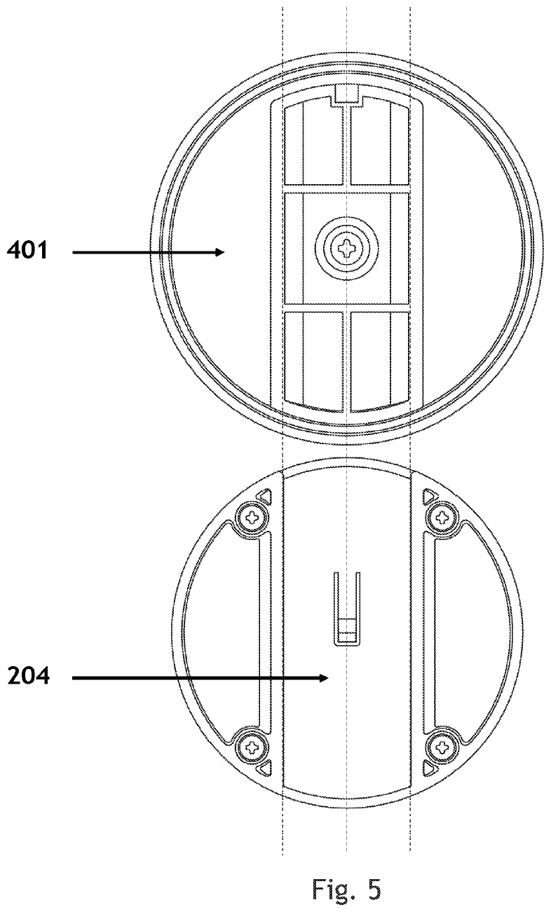

The housing of FIG. 1 has a handle 104 on top, which can be turned by hand. In an alternative embodiment, it can also be turned by a motor under battery operated (or plug in to the mains electricity supply) control. This handle, as shown in FIG. 4, has an elongated protrusion 401 of a size that fits into indentation 204 on the top surface of the feeder legs element as shown in FIG. 5.

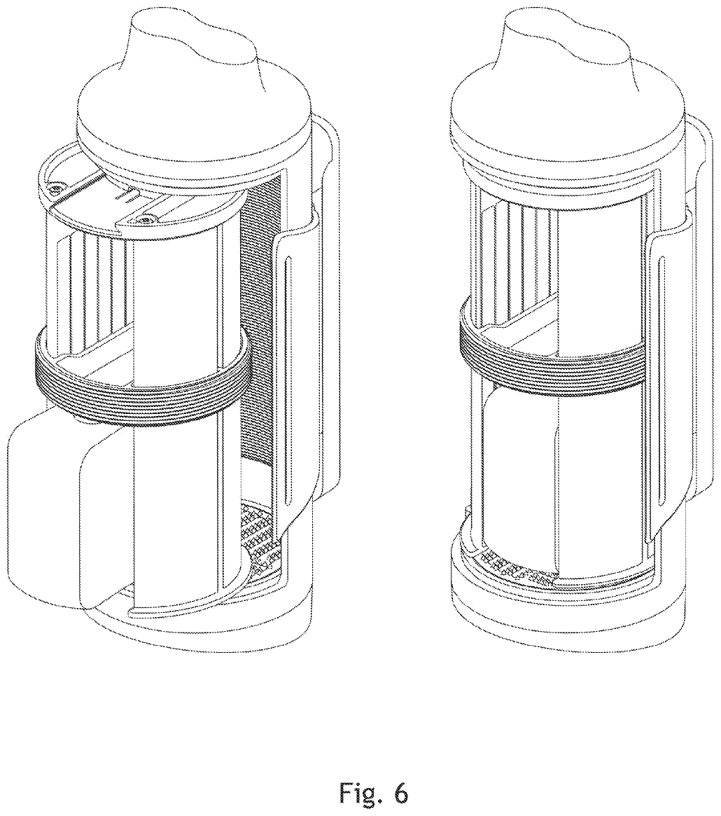

As shown in FIG. 6, when the door of the housing is open, a user inserts at least one bar of soap into the space between the two parallel vertical legs of the feeder legs element.

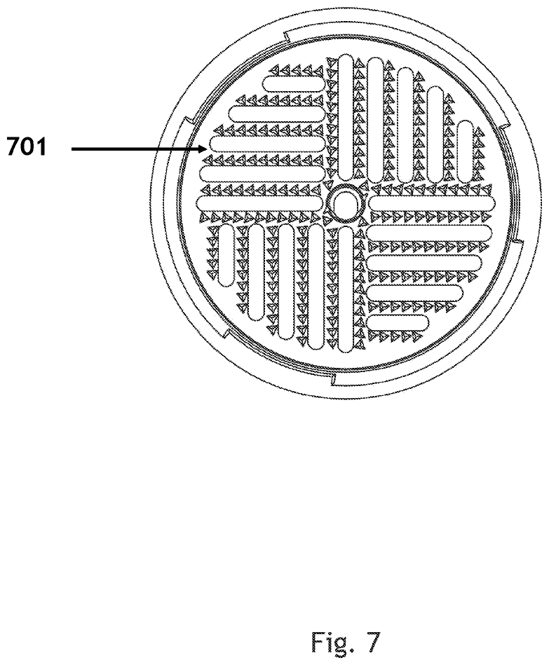

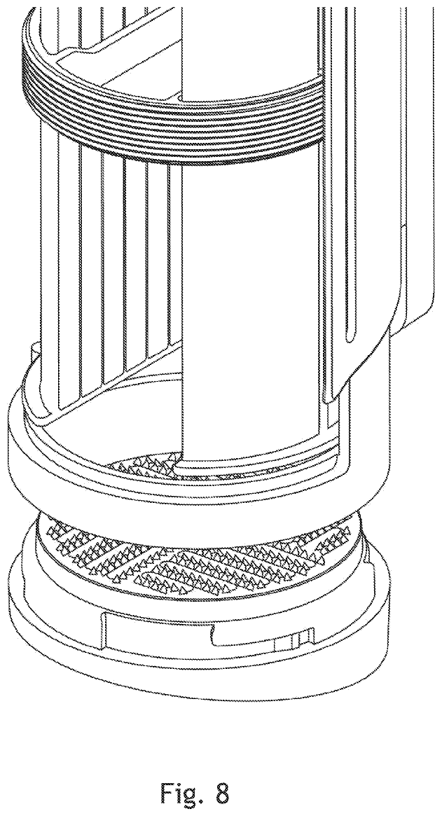

A grating element 701, shown in FIG. 7 is used to grate the bar of soap. This grating element is inserted into the bottom of the dispenser, during production of the soap dispenser, as shown in FIG. 8. In the preferred embodiment, it is not intended to be removable by the user.

In operation of the soap dispenser, the user turns the handle 104 at the top of the dispenser and this turning motion turns the feeder legs element 201 because the elongated protrusion 401 in the handle is forced against the indentation 204 on the top surface of the feeder legs element 201, by the turning action of the handle 104, causing the feeder legs element 201 to rotate.

The rotating of the feeder legs element 201 also rotates the circular feeder element 202, as was described above. The threads 203 of the circular feeder element engage with the threads on the inside surface of the dispenser housing, to direct the circular feeder element 202 downwards towards the bottom of the housing towards the grater 701, along the path of the threads. The circular feeder element 202 rotates around the inside of the housing in a circular motion, guided by the threads.

The bar of soap (or a plurality of bars of soap, stacked one on top of the other), then is forced downwards (because it is being pushed downwards by the flat undersurface 202c (of FIG. 2b) of the circular feeder element 202) whilst being rotated by the rotation of the circular feeder element 202.

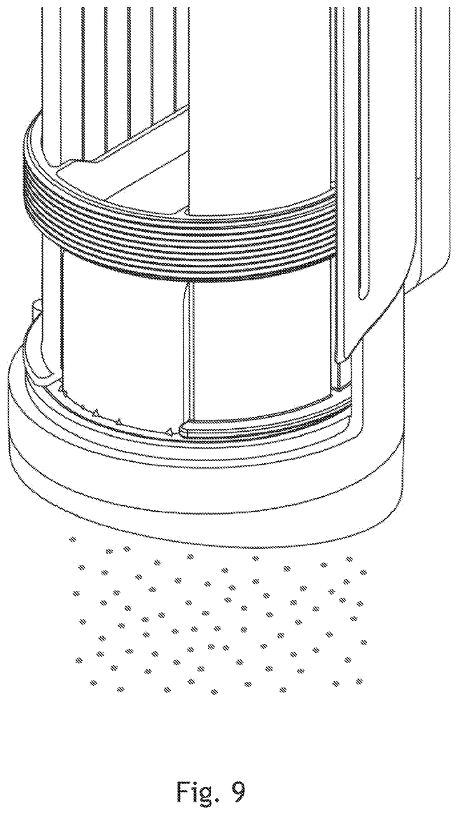

The bar of soap eventually reaches the grater 701, and the bottom surface of the bar of soap is then evenly grated by the grater, such that fine particles of soap are then ejected from the bottom of the dispenser, as shown in FIG. 9.

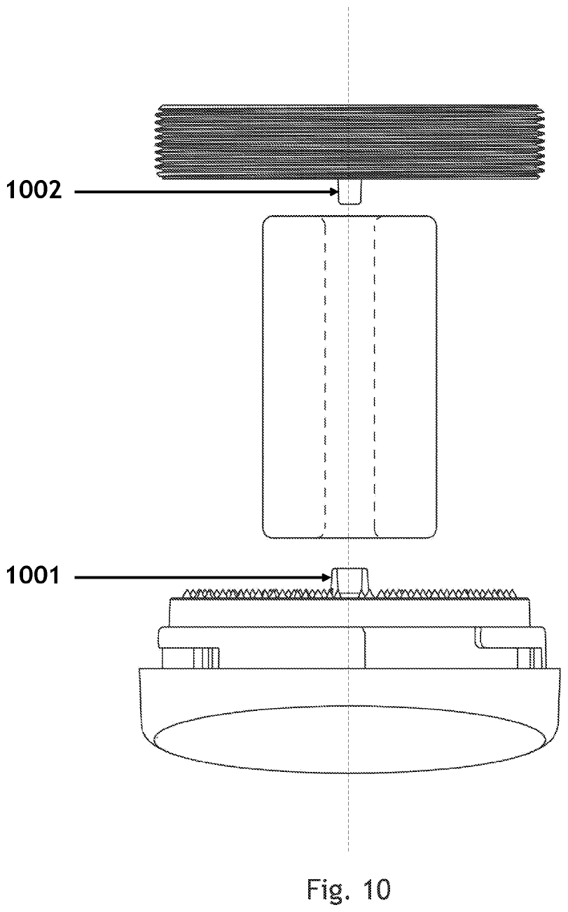

As shown in FIG. 10, there are two nipples (or protrusions), one nipple 1001 at the centre of the top surface of the grater 701, and the other nipple 1002 at the centre of the undersurface 202c of the circular feeder element 202 to hold the bar of soap into position to maintain its alignment during motion within the dispenser. This ensures that a maximum surface of the soap contacts the grater, to stop the bar of soap from sliding out of position. For example, this stops the bar of soap from getting caught in the threads at the back wall of the dispenser or on the inside door. This arrangement helps to guide the bar of soap in an accurate manner towards the grater.

The use of the threads, and the movement of the circular feeder element along the threads, and the use of the feeder legs element to provide rotation from the handle, helps to guide the bar of soap down towards the grater in a very even, uniform, manner, to make maximum use of the bar of soap in creating fine particles for washing.

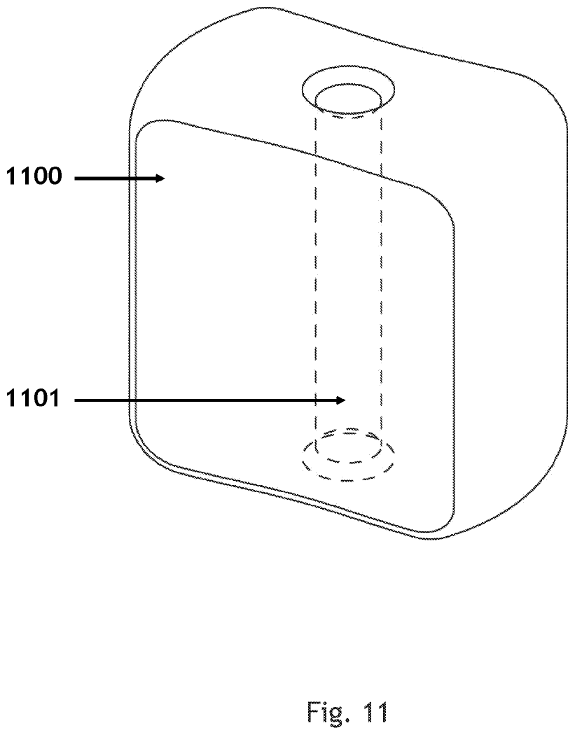

FIG. 11 shows a bar of soap which is arranged to work well with the dispenser described above.

As shown in FIG. 11, the bar of soap has a central hole 1101 running from top surface of the bar of soap to the bottom surface thereof, of approximately 1/28 th of the volume of the bar of soap and represents approximately 15% of the surface area of each of the top and bottom surfaces of the bar of soap.

The dimensions of the cuboid bar of soap are approximately 66.5 mm by 65.0 mm by 33 mm, and the diameter of the hole is 10 mm. The hole preferably runs through the whole length of the soap bar on the 65 mm plane. When the soap bar is inserted into the dispenser, the hole is oriented parallel with the central axis of rotation of the dispenser.

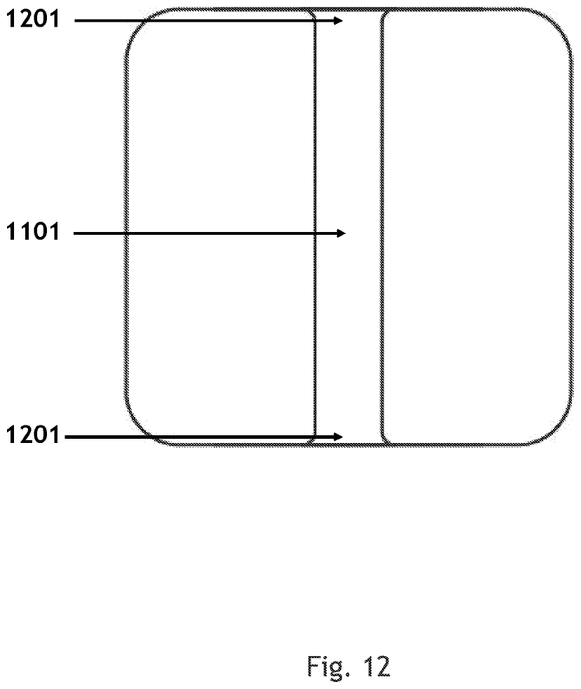

This central hole is shown in cross-section in FIG. 12. As shown in FIG. 12, the hole is preferably not a straight hole but instead is elongated at the top and bottom (see the elongated areas 1201). These elongated areas 1201 helps to make the bar of soap self-righting on the nipple at the centre of the grating of the dispenser as well as to the nipple on the underside of the circular feeder element, keeping the soap from gathering inside the thread on the inside of the dispenser wall and the inside of the door.

The use of a hole at the centre of the bar of soap helps greatly to reduce the mounding of soap that would occur if the hole were not present. Without the hole, the area at the very centre of the soap would not grate as it does not rotate against the grater at the very centre, this causes a mounding effect which would prevent the soap outside this area from making contact with the grater preventing the soap from being grated. This also results in an accumulation of soap at the centre of the bar, which can cause jamming of the dispenser elements, which in turn will prevent the remainder of the surface of the soap touching the grater, thus resulting in no soap particles being dispensed.

The size of the diameter could be altered within a range between 5 mm and 20 mm. If the diameter of the hole is too small, the soap around the edge of the hole will not be positioned above the grating surface, and this results in the mounding effect described above. However, if the hole is too large, the bar of soap won't fit securely on the nipples, and it would also call into question the integrity of the overall bar of soap, as the bar of soap could split from the hole to the outer edge of the bar or break apart altogether.

As shown in FIGS. 11 and 12, the edges of the bar of soap can be rounded, with an angle of approximately 15 to 20%, preferably 16%.

The rounded edges make holding the soap a more ergonomic and comfortable experience during the entire time that the bar of soap is being handled by a user, so from the time the bar is taken out of the packaging to the time it is inserted into the dispenser or used manually outside of a dispenser for washing hands. The rounded edges also help to reduce the chances of the rotating soap bar contacting the inside surfaces of the dispenser housing during operation of the dispenser.

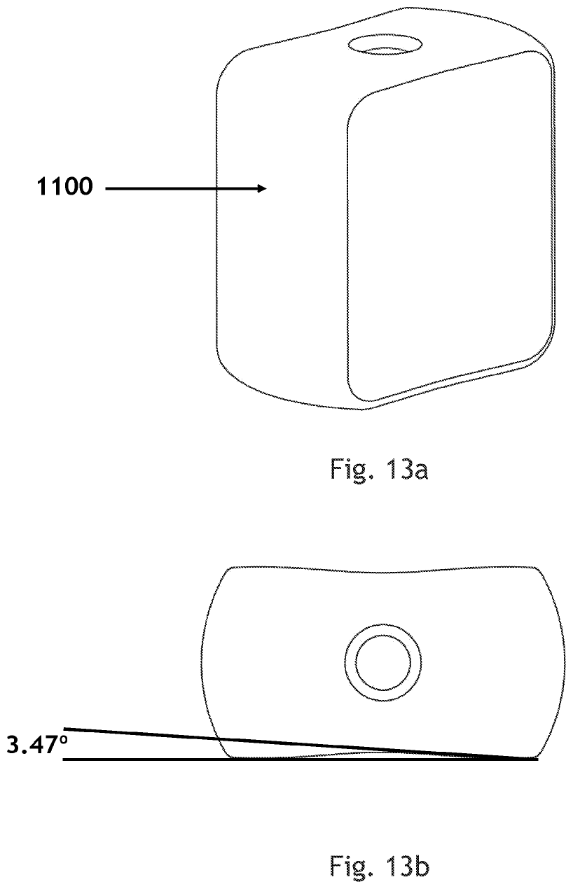

As shown in FIG. 13a and FIG. 13b, the bar of soap can have indented sides, with an angle of indentation being preferably about 3.5 degrees (shown in the top view FIG. 13b as being 3.47 degrees), but which could be within a range of 1.5 to 5.5 degrees.

The indented sides allow for the user to securely, firmly, and comfortably hold the soap when removing it from its packaging and when inserting it into the soap dispenser. The indented sides also reduce the risk of the sides of the soap bar contacting the inside surfaces of the housing of the dispenser as the soap bar rotates during operation of the dispenser.

A bar of soap designed to these new specifications make the bar much easier to insert into the dispenser, and much easier to use manually outside of such a dispenser, because it is much easier to pick it up by hand and makes the bar of soap work much better in the dispenser, as described above.

The bar of soap may be made of any materials traditionally used in soap making, such as fat and alkali (the alkali most common used is sodium hydroxide or potassium hydroxide).

1-18. (canceled)

19. A soap dispenser comprising:
a housing having an opening through which a bar of soap can be inserted into the housing, the housing having threads on an inside surface of the housing;
a grating element configured for shaving particles of soap from the bar;
a driving mechanism configured for both rotating the bar of soap about an axis of rotation and urging the bar of soap downwards onto the grating element to generate soap particles which are ejected from the bottom of the soap dispenser, wherein the driving mechanism includes a rotatable feeder legs element and a circular feeder element engaged with the feeder legs element, the circular feeder element having threads which engage with the threads on the inside surface of the housing; and
a centring element for maintaining the bar of soap centred on the axis as it rotates and as it wears, the centring element including a nipple protrusion located at the centre of the grating element for engaging a hole in the bar of soap,
wherein the circular feeder element has a flat bottom undersurface which is arranged to contact against the bar of soap when it is in position in the housing to push the bar of soap downwards in the housing onto the grating element as the circular feeder element rotates and the threads of the circular feeder element are engaged with the threads on the inside surface of the housing.

20. The soap dispenser of claim 19, wherein the opening is closable by a door.

21. The soap dispenser of claim 19, further comprising a handle engaged with the feeder legs element to rotate the feeder legs element when the handle is rotated, whereby the bar of soap is rotated, when it is located in the soap dispenser, to generate soap particles which are ejected from the dispenser.

22. The soap dispenser of claim 19, wherein the grating element is located at the bottom of the housing.

23. The soap dispenser of claim 19, wherein the housing is configured to receive more than one bar of soap into the housing, one on top of the other.

24. The soap dispenser of claim 19, wherein the centring element includes another nipple protrusion located at the centre of the flat bottom undersurface of the circular feeder element, to hold the bar of soap in alignment as it rotates.

25. The soap dispenser of claim 24, arranged to operate with a bar of soap having a hole at least in each end and desirably a through hole arranged to cooperate with the nipple protrusions.

26. The soap dispenser of claim 19, wherein the feeder legs element is attached to the circular feeder element such that when the feeder legs element rotates, the circular feeder element also rotates.

27. The soap dispenser of claim 19, wherein the threads of the circular feeder element run in a circumferential direction of the circular feeder element.

28. A soap dispenser suitable for containing a bar of soap, the soap dispenser comprising:
a housing having a front opening closeable by a door allowing insertion of a bar of soap into the housing, when the door is an open position;
a grating element configured for shaving particles of soap from the bar of soap;
a driving mechanism configured for both rotating the bar of soap about an axis and urging the bar of soap downwards onto the grating element to generate soap particles which are ejected from the bottom of the soap dispenser; and
a centring element for maintaining the bar of soap centred on the axis as it rotates and as it wears, wherein the driving mechanism is configured so that it is slidable between a first position inside the housing and a second position toward the front opening, whereby, when in the second position, a bar of soap may be inserted through the front opening into the housing of the soap dispenser.

29. The soap dispenser of claim 28, wherein the grating element is located at the bottom of the housing.

30. The soap dispenser of claim 28, wherein the housing is configured to receive more than one bar of soap into the housing, one on top of the other.

31. The soap dispenser of claim 28, wherein the housing has threads on an inside surface.

32. The soap dispenser of claim 31, wherein the driving mechanism includes a feeder legs element and a circular feeder element engaged with the feeder legs element, the circular feeder element having threads which engage with the threads on the inside surface of the housing.

33. The soap dispenser of claim 32, wherein the feeder legs element and the circular feeder element are arranged in the housing so that they can be slid forward toward the opening but not removed entirely from the housing, and disengaging the threads of the circular feeder element from the threads of the housing, to allow the bar of soap to be inserted into the soap dispenser.

34. The soap dispenser of claim 32, further comprising a handle engaged with the feeder legs element to rotate the feeder legs element when the handle is rotated, whereby the bar of soap is rotated, when it is located in the soap dispenser, to generate soap particles which are ejected from the dispenser.

35. The soap dispenser of claim 32, wherein the centring element has a flat bottom undersurface, wherein the flat bottom undersurface of the circular feeder element is arranged to contact against the bar of soap when it is in position in the housing to push the bar of soap downwards in the housing as the circular feeder element rotates and the threads of the circular feeder element are engaged with the threads on the inside surface of the housing.

36. The soap dispenser of claim 35, wherein the centring element includes a nipple protrusion located at the centre of the grating element for engaging a hole in the bar of soap and another nipple protrusion located at the centre of the flat bottom undersurface of the circular feeder element, to hold the bar of soap in alignment as it rotates.

37. A system comprising:
a soap dispenser comprising:
a housing having an opening for inserting a bar of soap;
a grating element for shaving particles of soap from the bar of soap;
a driving mechanism for both rotating the bar of soap about an axis and urging the bar of soap downwards onto the grating element to generate the soap particles which are ejected from the bottom of the soap dispenser; and
a centring element for maintaining the bar of soap centred on the axis as it rotates and as it wears; and
a bar of soap having a substantially cuboid shape having a length, a thickness and a width and having a clear hole of at least 5 mm diameter running centrally through the length of the bar of soap from a first end having a top surface to a second end having a bottom surface, the clear hole arranged to cooperate with the centring element to maintain the bar of soap centred on the axis.

38. The system of claim 37, wherein centring element includes a nipple protrusion located at the centre of the grating element for engaging the clear hole in the bar of soap.
